(19) United States
(12) Patent Application Publication
(10) Pub. No.: US 2026/0170471 A1
(43) Pub. Date: Jun. 18, 2026

(54) SYSTEMS, DEVICES, AND METHODS FOR CLOUD PAYMENTS

(71) Applicant: Pyramid Technologies, Inc., Mesa, AZ (US)

(72) Inventors: Cristion Dominguez, Mesa, AZ (US); Cody Gillespie, Chandler, AZ (US); Matthew Lang, Tempe, AZ (US); Gino Maneri, Cave Creek, AZ (US); Jonathan Durst, Lutz, FL (US); Kerrie Nollette, Phoenix, AZ (US); Tomislav Jeras, Gilbert, AZ (US); David Mays, Gilbert, AZ (US)

(21) Appl. No.: 19/425,287

(22) Filed: Dec. 18, 2025

Related U.S. Application Data
(60) Provisional application No. 63/735,393, filed on Dec. 18, 2024.

(51) Int. Cl. G06Q 20/08; G06K 7/14; G06Q 20/34

(52) U.S. Cl. CPC G06Q 20/085; G06K 7/1417; G06Q 20/34

(57) ABSTRACT

An example device of this disclosure may include processing components, memory components, display components, and input/output interfaces. The device may be configured to output a display of information related to a service or product offered by a vendor apparatus; specify a transaction for a user-selected quantity of the service or product to be provided by the vendor apparatus at a specified price; generate an output configured for enabling a user device to enter a connection with a cloud payment service to make a payment for the specified price to an account associated with the cloud payment device; detect a confirmation from the cloud payment service that the payment for the specified price has been paid to the account associated with the cloud payment device; and, in response to confirmation of the payment, output a control signal to the vendor apparatus to provide the service or product in the user-selected quantity.

### CROSS REFERENCE TO RELATED APPLICATION(S)

This application claims priority to U.S. Provisional Patent Application entitled “SYSTEMS, DEVICES, AND METHODS FOR CLOUD PAYMENTS,” Ser. No. 63/735,393, filed Dec. 18, 2024, the disclosure of which is hereby incorporated entirely herein by reference.

### FIELD

The present disclosure relates to the field of devices and services for making payments.

### BACKGROUND

Unattended payment peripheral devices enable proximate receipt of payments for services or products provided by a typically unattended apparatus, such as kiosks, photo booths, dart board games, pool tables, crane games for picking up a prize with a crane inside a case, and other attractions and equipment. Unattended payment peripheral devices include devices that accept cash and/or credit or debit cards for payment, to enable the apparatus to provide the service or product in exchange for payments while unattended or not necessarily attended by a person to process payments and administer the apparatus.

### SUMMARY

In an illustrative example of this disclosure, a device of this disclosure may include one or more processing components; one or more memory components, operably coupled to the one or more processing components; one or more display components, operably coupled to the one or more processing components; and one or more input/output interfaces, operably coupled to the one or more processing components. The device may be configured to output, via the one or more display components, a display of information related to a service or product offered by a vendor apparatus. The device may be configured to specify a transaction for a user-selected quantity of the service or product to be provided by the vendor apparatus at a specified price. The device may be configured to generate an output configured for enabling a user device to enter a connection with a cloud payment service to make a payment for the specified price to an account associated with the cloud payment device. The device may be configured to detect, via the one or more input/output interfaces, a confirmation from the cloud payment service that the payment for the specified price has been paid to the account associated with the cloud payment device. The device may be configured to, in response to detecting the confirmation that the payment for the specified price has been paid, output a control signal to the vendor apparatus to provide the service or product in the user-selected quantity.

In another illustrative example of this disclosure, a method includes outputting, by a cloud payment system via a display component, a display of information related to a service or product offered by a vendor apparatus. The method further includes specifying, by the cloud payment system, a transaction for a user-selected quantity of the service or product to be provided by the vendor apparatus at a specified price. The method further includes generating, by the cloud payment system, an output configured for enabling a user device to enter a connection with a cloud payment service to make a payment for the specified price to an account associated with the cloud payment system. The method further includes detecting, by the cloud payment system via an input/output interface, a confirmation from the cloud payment service that the payment for the specified price has been paid to the account associated with the cloud payment system. The method further includes, in response to detecting the confirmation that the payment for the specified price has been paid, outputting, by the cloud payment system, a control signal to the vendor apparatus to provide the service or product in the user-selected quantity.

In another illustrative example of this disclosure, a computing system includes one or more processing components; and one or more tangible computer-readable media comprising computer-readable instructions stored thereon. The computer-readable instructions are configured for causing the one or more processing components to output a display of information related to a service or product offered by a vendor apparatus. The computer-readable instructions are further configured for causing the one or more processing components to specify a transaction for a user-selected quantity of the service or product to be provided by the vendor apparatus at a specified price. The computer-readable instructions are further configured for causing the one or more processing components to generate an output configured for enabling a user device to enter a connection with a cloud payment service to make a payment for the specified price to an account associated with the cloud payment system. The computer-readable instructions are further configured for causing the one or more processing components to detect a confirmation from the cloud payment service that the payment for the specified price has been paid to the account associated with the cloud payment system. The computer-readable instructions are further configured for causing the one or more processing components to, in response to detecting the confirmation that the payment for the specified price has been paid, output a control signal to the vendor apparatus to provide the service or product in the user-selected quantity.

### BRIEF DESCRIPTION OF THE DRAWINGS

FIG. 1 depicts a combined perspective and conceptual view of a representative retail commercial environment comprising a cloud payment system that includes a cloud payment device implementing the cloud payment system, and unattended or without necessarily requiring being attended by a human operator, in an illustrative example of this disclosure.

FIG. 2 depicts a combined perspective view and conceptual schematic view of a cloud payment device, which shows additional internal detail including an overall system architecture, of an implementation of the cloud payment device of FIG. 1, in an illustrative example of this disclosure.

FIG. 3 depicts a cloud payment device including a tilted display screen, and an input reader slot positioned above the display screen, in an illustrative example of this disclosure.

FIG. 4 depicts a cloud payment device including a tilted display screen, and an input reader slot bezel frame which forms a slot bezel positioned below the display screen, in an illustrative example of this disclosure.

FIG. 5 depicts a cloud payment device including a tilted display screen, and an input reader slot positioned below the display screen and configured for receiving either payment cards or cash, in an illustrative example of this disclosure.

FIG. 6 depicts a cloud payment device comprising a payment device processor and RAM, and a payment system software application running on the payment device processor and RAM, in an illustrative example of this disclosure.

FIG. 7 depicts a point of sale (POS) application protocol interface (API) client software module, in accordance with an illustrative example of this disclosure.

FIG. 8 depicts another POS API client software module, in accordance with an illustrative example of this disclosure.

FIG. 9 depicts another POS API client software module, in accordance with an illustrative example of this disclosure.

FIG. 10 depicts another POS API client software module, in accordance with an illustrative example of this disclosure.

FIG. 11 depicts a local application data management software module, in accordance with an illustrative example of this disclosure.

FIG. 12 depicts a logger software module, in accordance with an illustrative example of this disclosure.

FIG. 13 depicts a General Purpose Input/Output (GPIO) controller software module, in accordance with an illustrative example of this disclosure.

FIGS. 14A-14C depict a view model software module which a cloud payment device may run, perform, or process through, in accordance with an illustrative example of this disclosure.

FIG. 15 shows a flowchart of an example method, in accordance with an illustrative example of this disclosure.

### DETAILED DESCRIPTION OF THE INVENTION

Payment devices and payment device systems of this disclosure may enable greater variety, convenience, and avoidance of risk and expense, relative to pre-existing, traditional unattended payment devices. Payment devices that accept cash are susceptible to being broken into or stolen. Payment devices that accept payment cards such as credit cards or debit cards require significant fees paid to the card providers. Payment devices and payment device systems of this disclosure may function to accept payments and enable paid functions with new benefits and without those and other drawbacks of existing devices that operate by accepting cash or credit and debit cards.

Various examples of this disclosure are implemented as cloud payment devices, which may operate with an Internet-mediated cloud payment service to enable and process payments to control unattended vendor apparatus to dispense or provide services or products. Payment device systems of this disclosure may operate in cooperation with an electronic cloud-based payment service provider, which may use cloud services and downloadable mobile device software applications. In various examples, payment device systems of this disclosure may interoperate with one or more existing third-party electronic payment service providers. In various examples, payment device systems of this disclosure may operate through a dedicated payment service provider associated with a certain business or financial service provider and with a dedicated downloadable mobile device software application, in addition to or instead of interoperating with one or more existing third-party electronic payment service providers. In various examples, payment device systems of this disclosure may either be an integrally self-contained product, or be modularly configured to facilitate being installed over or on top of or otherwise together with a pre-existing payment device or equipment. In various examples, payment devices and systems of this disclosure may make use of any payment service that operates over and using the Internet and may be considered to be “cloud” payment devices and systems, in some cases using conventional cloud characteristics such as flexible scalability, but without regard for whether any particular Internet-based payment service provider used by devices and systems of this disclosure adheres to any further specific functionality of any certain definition of “cloud” services.

A cloud payment device of this disclosure may include an electronic display screen that may connect or attach to a cloud-based billing center or payment service. A cloud payment device of this disclosure may include an electronic display screen disposed in a metal frame or cutout, or device face of another material, that faces a nominal operating position of a customer, or of a typical range of placement of a customer's eyes while using the cloud payment device. The display screen may enable user inputs to the cloud payment device for how many games to play or credits to select, or otherwise for how much quantity of a service or product for a vendor apparatus to provide. The cloud payment device may display via the display screen amounts for the to pay into the machine for user-selected quantities of games, credits, or other service or product to be provided. The cloud payment device may generate and display via the display screen an output such as a quick-response code (“QR code”) or other graphical code, which encodes instructions to open a cloud services payment application (“app”) on a user device and connect the user device to a cloud payment service provider, and to complete the payment on the user's mobile device. The user device may make the payment via the cloud payment service, which may respond by sending a notification or transferring a payment to an account associated with the cloud payment device of this disclosure that the cloud payment service has accepted the payment for the specified transaction.

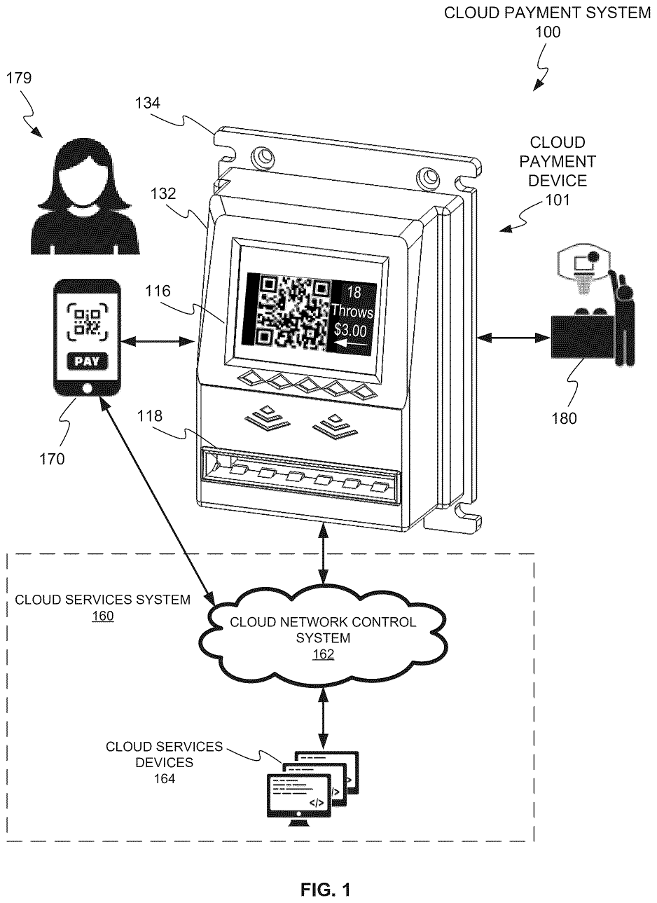

FIG. 1 depicts a combined perspective and conceptual view of a representative retail commercial environment comprising a cloud payment device 101 of this disclosure implementing a cloud payment system 100, and unattended or without necessarily requiring being attended by a human operator, in an illustrative example of this disclosure. Cloud payment device 101 comprises a body 132, a mechanical frame 134, a display screen 116, and an input reader slot 118, in this example. Cloud payment device 101 is in operable communication with a vendor apparatus, which may be any type of payment-operated equipment, and which is illustratively an automated basketball game apparatus 180 in the illustrative example of FIG. 1. Automated basketball game apparatus 180 enables a player to make a certain number of throws of basketballs at a basketball hoop per game, in exchange for a payment facilitated by cloud payment device 101, in the illustrative example of FIG. 1.

Mechanical frame 134 may include mechanical features, such as annuli and cavities as shown in FIG. 1 for receiving screws or nails, to facilitate mechanical attachment of cloud payment device 101 to a vendor apparatus such as automated basketball game apparatus 180, or to a surface proximate to the vendor apparatus and facilitating operable coupling therewith, in the illustrative example of FIG. 1. Cloud payment device 101 may thus be configured to process user payments for automated basketball game apparatus 180 or other vendor apparatus, and engage usage of automated basketball game apparatus 180 or other vendor apparatus on behalf of a user 179 making the payment. Cloud payment device 101 may be operably connected or coupled to automated basketball game apparatus 180, such as by having a hardwire connection with automated basketball game apparatus 180 or by being wirelessly connected with a wireless communication interface of automated basketball game apparatus 180, or may otherwise be in operable communication with automated basketball game apparatus 180, in various examples.

In various examples, cloud payment device 101 may be embodied as a single integrated device capable of receiving and processing cloud payments, and of accepting traditional cash and/or card payments via input reader slot 118. In various examples, cloud payment device 101 may be embodied as a mounting device or bezel device that is configured to fit over a pre-existing traditional payment processing device (not separately depicted in FIG. 1). A traditional payment processing device may be configured to receive and process payments via one or more of cash and/or debit and/or credit cards, and a mounting bezel configuration of cloud payment device 101 may be configured to be installed overlaid on top of and fittingly with functional interface elements of the traditional payment processing device. In various examples, input reader slot 118 may be an integrated component of cloud payment device for accepting cash and/or payment cards as flexible alternative payment forms other than making cloud payments. In other examples, input reader slot 118 may be a component of a pre-existing traditional payment processing device configured for receiving cash and/or payment cards, and cloud payment device 101 may be configured with an open slot bezel frame or slot bezel shaped to fit around and expose input reader slot 118 of the separate underlying traditional payment processing device when cloud payment device 101 is fitted over the traditional payment processing device. Further examples of these various configurations are discussed below.

More generally, both for example implementations in which cloud payment device 101 forms a single device with both cloud payment and traditional payment functionality, and in which cloud payment device 101 forms an overlay cloud payment device configured to fit over and incorporate the functions of a pre-existing traditional payment device, the cloud payment functionality of cloud payment device 101 may be functionally considered a cloud payment bezel over traditional payment functionality. In various implementations, thus, cloud payment device 101 may also be generally considered to be and referred to as a cloud payment bezel device or as a QR code cloud payment bezel device.

Cloud payment device 101 may establish a communicative connection with a user mobile device 170, such as smartphone 170 which user 179 may use to interact with cloud payment device 101, such that cloud payment device 101 may be configured to accept and process user payments via smartphone 170 for automated basketball game apparatus 180 or other vendor apparatus via smartphone 170. In other examples, cloud payment device 101 may interact with another user mobile device 170 such as a tablet computer or laptop computer or other user device 170, in various examples, any of which may also be implied for other examples in the discussion of smartphone 170 in this example. Cloud payment device 101 may be configured to interact with user mobile devices 170 via one or more payment modalities, including via one or more cloud payment applications loaded and running on smartphone 170, which may use a cloud services system 160 for making payments.

Cloud payment device 101 may be configured to generate an output configured for enabling smartphone 170 or another user device 170 to enter a connection with a cloud payment service to make a payment for the specified price to an account associated with cloud payment device 101. Generating the output configured for enabling the user device 170 to enter a connection with a cloud payment service may include generating a graphical code, such as a QR code or other type of graphical code, that encodes computer-readable software instructions for smartphone 170 or other user device 170 entering a connection with the cloud payment service to make the payment for the specified price to the account associated with cloud payment device 101. Generating the output configured for enabling the user device 170 to enter a connection with the cloud payment service may, in other examples, otherwise include generating an output that otherwise indicates a manner of establishing a cloud-based making an electronic payment, in computer-readable instructions and/or with human-readable instructions.

Cloud payment device 101 may also be configured to receive payments from debit cards and credit cards via insertion into input reader slot 118 and/or tapping on display screen 116, or in the form of cash deposited into input reader slot 118. Display screen 116 may include additional input components such as a radio frequency identification (RFID) tag or other component to enable receiving payment card information from a debit or credit card being tapped on or positioned proximate to display screen 116, in some examples.

Cloud services system 160 may include cloud network control system 162 and cloud services devices 164, as in the example of FIG. 1. Cloud services system 160 may include any of a variety of configurations of networks, devices, load balancers, networking fabrics, and other cloud resources, in various examples.

In an illustrative example, user 179 may use smartphone 170 to engage cloud payment device 101 to enable user 179 to play one or more games with automated basketball game apparatus 180. User 179 may press a start button on automated basketball game apparatus 180, or on display screen 116 or elsewhere on cloud payment device 101. Cloud payment device 101 may also initiate a game enrollment process, and display payment instructions on display screen 116, in response to sensing user 179 and/or smartphone 170 entering the proximity of cloud payment device 101 and/or automated basketball game apparatus 180, in some examples. Cloud payment device 101 may respond to user engagement, through selecting a start button, proximity, or other means of initially establishing engagement, by outputting vendor apparatus options and payment modality outputs via display screen 116, in various examples. For example, cloud payment device 101 may output, for display on display screen 116, one or more options for a proposed number of games to play with automated basketball game apparatus 180, and a proposed price for each option of proposed number of throws or proposed number of games to play with automated basketball game apparatus 180.

In response to cloud payment device 101 receiving a user selection input selecting a quantity of basketball throws at a specified price, cloud payment device 101 may generate and output a graphical code or other kind of code, which encodes the specified transaction with the user-selected number of throws and the corresponding price, such as a QR code, as shown in FIG. 1, and which may be scanned by a user device 170. FIG. 1 shows cloud payment device 101 in a state of outputting via display screen 116 a view of a user-selected number of throws and the corresponding price, such as 18 throws for $3.00 as shown in display screen 116 in FIG. 1, and a generated QR code that encodes this specified transaction along with instructions for making a payment for the indicated price via a cloud payment service, in a form that is scannable by smartphone 170. Cloud payment device 101 may thus display a QR code which enables smartphone 170 to establish a payment connection with a cloud payment service via cloud services system 160. Cloud payment device 101 may thereby enable user 179 to scan a graphical code displayed on display screen 116 with smartphone 170 to engage a user interface window on smartphone 170 to accept and pay for a proposed number of games with automated basketball game apparatus 180.

As part of this process, cloud payment device 101 may communicate with a cloud software application running on cloud services system 160 which may also communicate with smartphone 170, and accept and transmit a payment indicated by cloud payment device 101 from an account held by user 179 and authorized for payment via a corresponding software application running on smartphone 170. Cloud payment device 101 may use and leverage any third-party cloud payment processing software application, or a cloud payment processing software application of its own, to accept an authorized payment made via smartphone 170.

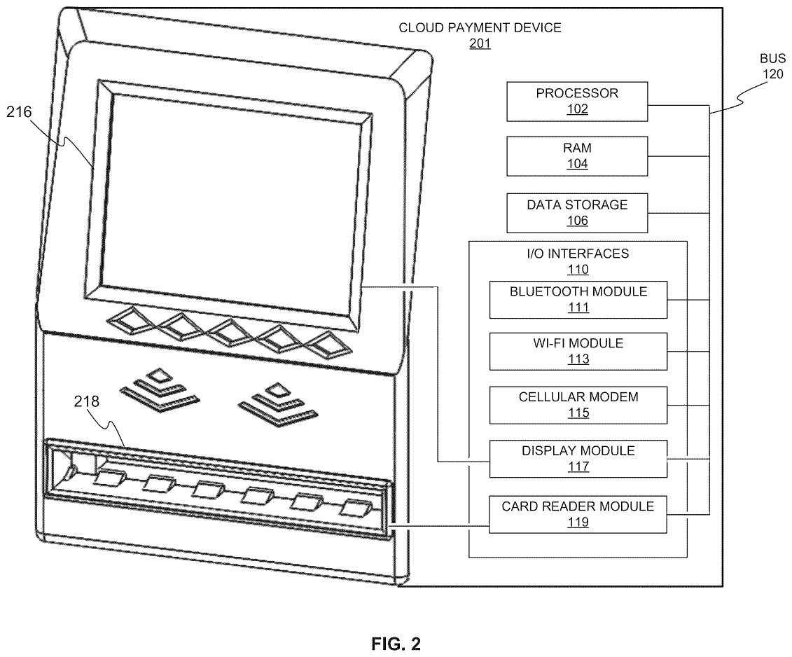

Cloud payment device 101 may thus interact with smartphone 170 to initiate and implement a payment process to pay for gameplay with automated basketball game apparatus 180, in the example of FIG. 1, or to pay for any other types of services or goods in other examples. Cloud payment device 101 may implement a payment process via cloud services system 160. These and other aspects of cloud payment device 101 are further described below, with reference to FIG. 2.

FIG. 2 depicts a combined perspective view and conceptual schematic view of another example cloud payment device 201, which may show additional internal detail, including an overall system architecture, of an implementation of cloud payment device 101 of FIG. 1, in an illustrative example of this disclosure. Cloud payment device 201 includes one or more processing components such as processor 102, one or more memory components such as random access memory (RAM) 104, one or more data storage components such as data storage 106, and one or more input/output (I/O) interface or interfaces 110, some or all of which may be interconnected via one or more buses, fabrics, or other interconnect elements such as bus 120. Memory functions and data storage functions may be intertwined in any of various configurations, and a “memory component” of a device of this disclosure may broadly include both one or more powered memory components and/or one or more data storage components 106, in various examples.

I/O interfaces 110 may illustratively include a Bluetooth module 111, a Wi-Fi module 113, a cellular modem 115, a display module 117 which may be connected with and control and communicate with display screen 216, a card reader module 119 which may be connected with and control and communicate with input reader slot 218, and any other input/output components or communication components, and may collectively be referred to as an input/output interface, in the example of FIG. 2 and other examples of this disclosure. Bluetooth module 111, Wi-Fi module 113, cellular modem 115, display module 117, and card reader module 119 may be implemented and/or embodied in any combination of generalized hardware, specialized hardware, firmware, and software, in various examples. Cloud payment device 201 may connect to a cloud payment service provider and to its associated account with the cloud payment service provider via a cellular connection, via a WiFi or ethernet Internet connection, through a satellite Internet service provider connection, or via any other mechanism of communications consistent with connecting with a cloud service.

In one example implementation, cloud payment device 201, and processor 102 and various further architecture aspects thereof, may be configured with an Adafruit Raspberry Pi 3 Model B+. (Adafruit and Raspberry Pi are trademarks of Adafruit Industries LLC of New York, New York, and are used here for illustrative functional descriptive purposes only for an illustrative example implementation of the present disclosure and not with any implication of association or endorsement.) Further example implementation example details of a Raspberry Pi implementation of cloud payment device 201 may be as follows. Display screen 216 of cloud payment device 201 may be implemented as a 2.4-inch 320 by 240 pixel thin-film-transistor (TFT) touchscreen display. These parameters are illustrative examples only, and other examples may incorporate larger or smaller display screen sizes or higher-density or lower-density pixel counts per area. Cloud payment device 201 may be implemented with a custom arbiter board, which may a custom-made component of cloud payment device 201 and which may be operatively coupled to both a processor 102 in the form of the processor of a Raspberry Pi 3 Model B+ and to display screen 216. A custom arbiter board may also implement display module 117 and other aspects of I/O interfaces 110 or aspects thereof, and may thus control signals and communications between processor 102 and display screen 216.

Cloud payment device 201 may be implemented using an operating system and software frameworks such as the Raspberry Pi Operating System (OS), the Chromium framework, the ASP. NET Blazor web framework, and the ReactiveUI graphical user interface (GUI) user interaction framework, which may be stored on data storage 106, loaded by processor 102 into RAM 104, and run by processor 102, in some examples. The custom arbiter board or other aspects implementing I/O interfaces 110 may also communicate between processor 102 and control elements of an external vendor apparatus, such as automated basketball game apparatus 180, a photo booth, a claw machine game, or any other example vendor apparatus. In various examples, processor 102 may be integrated with aspects of I/O interfaces 110 such as General Purpose Input/Output (GPIO) pins, and the custom arbiter board may connect between and route control signals between the GPIO pins and control elements of the external vendor apparatus.

Processor 102 may also run a cloud payment vendor apparatus access software application built with the ASP. NET Blazor web application, running on the Raspberry Pi OS and the Chromium framework, and incorporating ReactiveUI framework user interaction elements, which processor 102 may run and display on display screen 216 via the custom arbiter board of I/O interfaces 110. The cloud payment vendor apparatus access software application running on cloud payment device 201 may include user interaction graphical elements, such as selectable buttons or selectable icons, displayed on display screen 216, configured for user interaction functions, such as selecting a number of games to play, or a number of photos to be taken in a photo booth, for example. ReactiveUI aspects of the cloud payment vendor apparatus access software application running on processor 102 of cloud payment device 201 may route user input selections to the custom arbiter board of I/O interfaces 110, which may translate the software signals of the user inputs into control signals that the custom arbiter board transmits to control function hardware elements of the vendor apparatus, such as to release a certain selected and paid-for number of standard or miniature basketballs from a recirculating basketball storage compartment, to enable user control of a mechanical claw for a certain selected and paid-for duration of time, or to take and print a selected and paid-for number of photographs, or to engage other user-selectable vendor apparatus controls, in various examples.

Cloud payment device 201 may thus be enabled to interact with an external user device 170 and an external vendor apparatus, such as smartphone 170 and automated basketball game apparatus 180 respectively in the illustrative example of FIG. 1, to enable processing a cloud payment for accessing the vendor apparatus, via interaction with a cloud payment software application loaded and running on smartphone 170. Cloud payment device 201 may further be enabled to, in response to user agreement with payment terms in exchange for vendor apparatus services via a cloud payment software application loaded and running on smartphone 170, receive a payment or a notification of payment made from a cloud payment processing software service running on cloud services system 160. Cloud payment device 201 may further be enabled to, in response to processing a user payment via smartphone 170 and cloud payment processing software service running on cloud services system 160, engage the vendor apparatus for user access of services or goods provided by the vendor apparatus, in various examples.

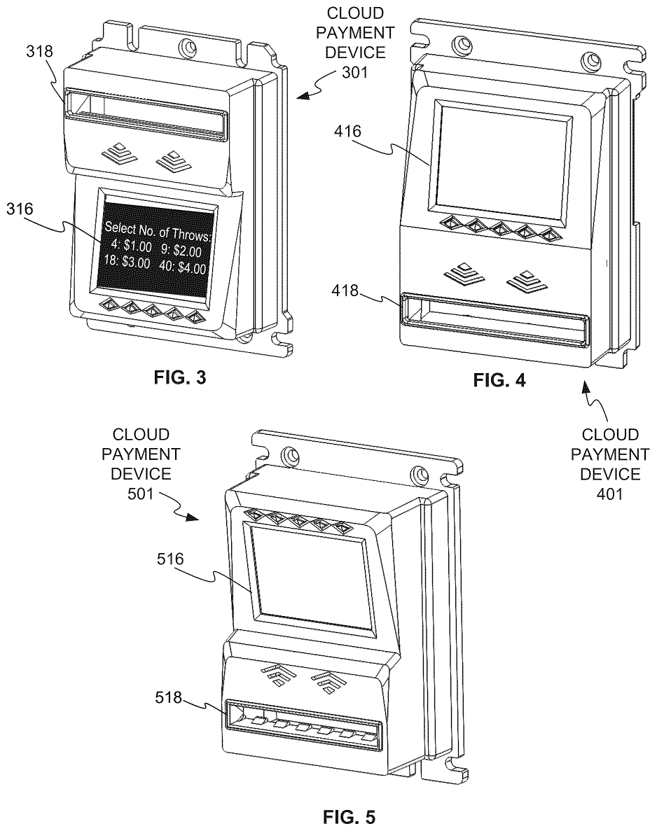

FIGS. 3-5 depict cloud payment devices 301, 401, 501, respectively, in additional examples of cloud payment devices of this disclosure. Cloud payment devices 301, 401, 501 of the examples of FIGS. 3-5 are analogous in various ways to cloud payment devices 101 and 201 of FIGS. 1 and 2. Whereas cloud payment device 101 and 201 of FIGS. 1 and 2 include input reader slot 118 positioned below display screen 116, and either an integrated component or a component of an underlying pre-existing device, configured for receiving either payment cards or cash, cloud payment device 301 of FIG. 3 includes input reader slot bezel frame 318 positioned above display screen 316. In the example of FIG. 3, input reader slot bezel frame 318 is configured for conformingly fitting over an input reader slot of an underlying traditional payment receiving device, where the underlying traditional payment receiving device input reader slot may be configured for receiving cash, payment cards, or both. Cloud payment device 301 may also be configured to interconnect electronically with and control the underlying traditional payment receiving device, and form a functionally integrated whole with the underlying traditional payment receiving device which is thereby able to receive and process electronic cloud payments or traditional cash or card payments, in various examples. Cloud payment device 301 may be implemented in various configurations that may fit over a pre-existing traditional payment device made by a same company that makes an implementation of cloud payment device 301, and in various configurations that may fit over any pre-existing traditional payment devices made by any arbitrary device makers.

FIG. 3 depicts a cloud payment device 301 including a tilted display screen 316, and an input reader slot 318 positioned above display screen 316, in an illustrative example of this disclosure. FIG. 3 also shows another example of an output screen that cloud payment device 301 outputs for display via display screen 316, in an illustrative example of this disclosure. In the view and state shown in FIG. 3, cloud payment device 301 outputs a user selection menu to display screen 316 for a user to select a number of basketball throws. Cloud payment device 301 also outputs for display to display screen 316, as part of the user selection menu, a corresponding price with each option for a number of throws. The view and state outputted by cloud payment device 301 in FIG. 3 may thus be at an earlier stage of user interaction than the view and state shown in FIG. 1 to be outputted via display screen 116 by cloud payment device 101. The display screen view and state as shown in FIG. 1, showing a view of a specified transaction with a user-selected quantity of vendor apparatus service and corresponding price, and corresponding transaction QR code generated by cloud payment device 101, may thus be a subsequent view and state after cloud payment device 101 has received a user input selection on a user transaction menu screen view as shown in FIG. 3. In other examples, cloud payment device 301 may display a user selection menu in any of various formats, such as with up and down buttons to toggle among available selections for any arbitrary options of a number of basketball throws or any other service or product dispensed by an associated vendor apparatus.

FIG. 4 depicts a cloud payment device 401 including a tilted display screen 416, and an input reader slot bezel frame 418 which forms a slot bezel positioned below display screen 416, in an illustrative example of this disclosure. As in the examples of cloud payment devices 101 and 201 of FIGS. 1 and 2 the display screen is positioned above the input slot. As in the example of FIG. 3, input reader slot bezel frame 418 is also configured for conformingly fitting over an input reader slot of an underlying traditional payment receiving device, where the underlying traditional payment receiving device input reader slot may be configured for receiving cash, payment cards, or both, as in the example of FIG. 3. Cloud payment device 401 as a whole may be configured and considered to be a bezel over an underlying traditional payment device, while input reader slot bezel frame 418 specifically is a bezel frame configured for defining exposed user access to the cash or payment card receiving slot or both of the underlying traditional payment device. The examples of FIGS. 3 and 4 thus show different configuration options for positioning an input reader slot bezel frame over an underlying tangible form payment slot of a separate payment device for receiving tangible forms of payment such as cash and/or cards, and for positioning the display screen relative to the position of the payment slot.

FIG. 5 depicts a cloud payment device 501 including a tilted display screen 516, and an input reader slot 518 positioned below display screen 516 and configured for receiving either payment cards or cash, in an illustrative example of this disclosure. In contrast to display screens 116-416 as shown in FIGS. 1-4, display screen 516 is tilted downward, to be more suitable for applications in which display screen 516 is nominally targeted to be positioned above a nominal position of a user's face or focus of attention. The example of FIG. 5 thus shows another variation in orientation of the display screen of the cloud payment device as opposed to the upward tilt of display screens 116, 216, 316, 416 of the examples of FIGS. 1-4, which may be optimized for applications in which the display screen is nominally targeted to be positioned below a nominal position of a user's face or eyes. In some examples, input reader slot 518 may be configured for receiving only payment cards, such as debit cards and credit cards, and not configured for receiving cash, which may be simpler and more inexpensive, and better suited for applications that target only electronic payments via payment software application or payment card.

Thus, in various examples, a cloud payment device of this disclosure such as cloud payment devices 101, 201, and 501, as discussed above, may include a tangible payment processing component configured to process payments via tangible payment forms, such as one or more of cash and payment cards such as credit cards, debit cards, and gift cards. In various examples, cloud payment device 101 may further be configured to output user options for paying via the cloud payment service or the one or more of cash and payment cards. In various examples, a cloud payment device of this disclosure such as cloud payment devices 301 and 401, as discussed above, may include a frame body, wherein the frame body is configured to be attached over a face of a separate tangible payment processing device configured to process payments via one or more of cash and payment cards. For example, cloud payment devices 301 and 401 may include input reader slot bezel frames 318 and 418, respectively, as discussed above, which may form open slot bezels configured for conformingly fitting over an input reader slot of an underlying traditional, tangible payment medium payment receiving device, where the underlying traditional payment receiving device input reader slot may be configured for receiving cash, payment cards, or both.

Thus, in various examples, a cloud payment device of this disclosure such as at least cloud payment devices 301 and 401 may be configured to operably connect with a separate tangible payment processing device, process payments made through the separate tangible payment processing device, and control the vendor apparatus in response to payments processed through the separate tangible payment processing device. The frame body of a cloud payment device 301 or 401 may thus be further configured with an open slot bezel such as input reader slot bezel frames 318 and 418 that is shaped to fit around an input reader slot of the separate payment processing device, such that the open slot bezel of the cloud payment device enables the separate tangible payment processing device to operably receive one or more of cash and payment cards through the open slot bezel of the cloud payment device 301 or 401. Cloud payment device 301 or 401 may be configured to be operably connected with the underlying separate payment processing device to credit a traditional cash or payment card payment for control of the vendor apparatus to provide or dispense the service or product, in some examples, and may thereby flexibly offer to process payments either by cloud payments or by traditional cash or payment cards.

In various examples of a cloud payment device of this disclosure such as cloud payment devices 101-501 may be configured with one or more display components that may include a display screen that is tilted at an intermediate angle relative to a facing plane of the cloud payment device, such as display screens 116-516. The facing plane of the cloud payment device may be defined by a plane of the longer length and width dimensions of the device and of its mechanical mounting frame, and such that the facing plane may be orthogonal to the input orientation of cash or payment cards, in various examples. The display screen may be tilted at an intermediate angle relative to a facing plane of the cloud payment device in that the display screen may be tilted at an angle between 0 degrees and 90 degrees relative to the facing plane of the device, in various examples. In illustrative examples, display screens 116-516 may be tilted at an angle of between approximately 5 degrees and 45 degrees relative to the facing plane of cloud payment devices 101-501. In other examples, a cloud payment device of this disclosure may be tilted at any angle, or not tilted, relative to a facing plane of the device. In various examples a cloud payment device of this disclosure may be configured with a display screen that is flush and co-planar with a facing plane of the cloud payment device (not depicted in FIGS. 1-5).

In various examples, the display screen may be tilted such that, in a nominal installed orientation of the device, such as being installed on a vertical surface of or proximate to a vendor apparatus, the intermediate angle is tilted at an upward tilt relative to the facing plane of the device. Illustrative examples of this are shown with cloud payment devices 101-401 of FIGS. 1-4 which are shown in an illustrative orientation with the facing plane generally vertical, and with respective display screens 116-416 tilted facing at an upward angle relative to the generally vertical facing planes of cloud payment devices 101-401. These tilts may be useful where the cloud payment device may be nominally installed in a vertical orientation at a lower height than the average height or than much of the range of heights of a nominally expected range of positions of a customer's or user's eyes when engaging with the cloud payment device, for example.

In various examples, the display screen may be tilted such that the intermediate angle is tilted at a downward tilt relative to the facing plane of the device, such as with the example of display screen 516 of cloud payment device 501 of FIG. 5. This downward tilt may be useful where the cloud payment device may be nominally installed either on a horizontal surface of or proximate to a vendor apparatus below an expected height of a customer's eyes, or on a vertical surface above an expected height of a customer's eyes, so that display screen 516 is again tilted to help the customer see the screen more easily in these other example contexts. A cloud payment device of this disclosure may have either an adjustable or fixed angle and orientation of tilt, in various examples.

Further cloud payment devices in additional examples of this disclosure may be of any of a variety of additional physical configurations and form factors. Further cloud payment devices in additional examples of this disclosure may have one or more display screens positioned flat in line with a vertical frame thereof, or tilted in any orientation, or mounted on a swiveling stalk to be free to tilt in various orientations, in various examples. Further cloud payment devices in additional examples of this disclosure may include a display screen for interaction with a user device and/or a user and for processing electronic cloud payments, and with or without capability for receiving tap or proximity payment interactions with payment cards, and may not include any reader slot for receiving insertion of reader cards or cash, in various examples. Further cloud payment devices of this disclosure may have a display component other than a display screen, such as a display projector configured to project a display output onto a separate screen or wall, or a display caster configured to transmit a display output to a user device or other separate device, in various examples. Further cloud payment devices have further configurations and form factors besides those described above in further examples of this disclosure.

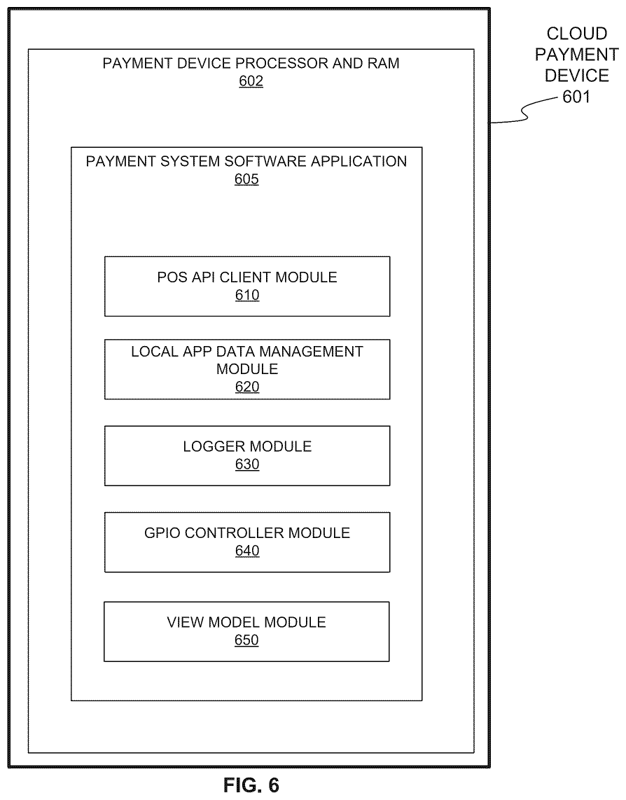

FIGS. 6-14 depict another example cloud payment device 601, and various cloud payment system software modules which may run on cloud payment device 601, in additional examples of cloud payment device systems of this disclosure. Cloud payment device 601 may be an example implementation of any of cloud payment devices 101, 301, 401, 501 of FIGS. 1-5, in various examples.

FIG. 6 in particular depicts cloud payment device 601 comprising payment device processor and RAM 602, and payment system software application 605 running on payment device processor and RAM 602, in an illustrative example of this disclosure. Payment system software application 605 may comprise various software modules as described below.

Software implementing cloud payment system software modules of FIGS. 6-14 may be stored on data storage 106 of FIG. 2 and may be included in a payment system software application 605 in an example of this disclosure loaded and running on processor 102 and RAM 104 of FIG. 2 and/or payment device processor and RAM 602 as depicted in FIG. 6, in accordance with various examples of this disclosure. Payment system software application 605 may include point of sale (POS) application protocol interface (API) client module 610 (“POS API client module 610”), local application (“app”) data management module 620, logger module 630, general purpose input/output (“GPIO”) controller module 640, and view model module 650, in various examples of this disclosure. These modules may include or correspond with elements of software code, firmware, hardware components, and/or abstract representations thereof, and/or any combinations thereof, in accordance with various examples.

The purposes and functions of each of these modules may be as indicated by their names. POS API client module 610 may send HTTP requests, such as HTTP POST requests, to create or otherwise enter a specified transaction, and to track the specified transaction, for example. Local app data management module 620 may store software application data locally on device, in RAM and/or data storage of cloud payment device 601, and may make such data available for subsequent reference, for example. Logger module 630 may log or save actions or outputs of the software application into log files stored in data storage of cloud payment device 601, for example. GPIO controller module 640 may read inputs and write or control outputs via GPIO pins, for example. View model module 650 may control the state of graphical user interface elements displayed on a display screen of cloud payment device 601, for example. View model module 650 may use and integrate the functions of modules 610-640 to control the user interface view and functionality that cloud payment device 601 displays and enables on a display screen thereof, to provide the overall user experience of making a cloud payment transaction in exchange for making a user selection of a number of games, photos, or other vendor services with the applicable vendor apparatus, such as purchasing credits and making selections for the vendor apparatus via a cloud payment QR code or other cloud payment interface element displayed on the display screen of cloud payment device 601, for example. These elements of FIG. 6 and further details thereof are further described in connection with the depictions of the following figures.

In an example cloud control and payment method that cloud payment device 601 may enable, cloud payment device 601 may initially present a default initial graphical output on a display screen thereof, which may include one or more graphical buttons or other user-selectable graphical elements enabling a user to begin making cloud payment and vendor apparatus control selections. This may include a button for a user to initially select to open a menu of options for payments in exchange for a selected number of apparatus control aspects, such as a selected number of credits for a corresponding number of basketballs to shoot, photos to take and print, or a selected number or duration of other services or products offered by an associated vendor apparatus. Cloud payment device 601 may receive an initial user input to open a menu, and cloud payment device 601 may respond by displaying a menu of numbers or durations of one or more vendor services or products, with corresponding prices. Cloud payment device 601 may then receive a user input selecting a certain number of credits, or equivalent indicators of vendor apparatus services or products, with a corresponding price. Cloud payment device 601 may output a button or other user-selectable graphical element for confirming the user selection of credits or equivalents and price, in some examples. Cloud payment device 601 may receive a user input affirming the confirmation.

Cloud payment device 601 may then output a graphical element enabling initiating of a user payment for the selected price for the selected number of credits or equivalent. As an example of this, cloud payment device 601 may generate and output a QR code on the display screen thereof, in various examples. Cloud payment device 601 may generate and output other kind of graphical code or other means of initiating a payment transaction, in various examples. Cloud payment device 601 may generate a QR code or other code to correlate with one particular third-party cloud payment service, with its own associated custom cloud payment service provided by the maker of cloud payment device 601, or flexibly enabling user selection and usage from among multiple different cloud payment services, in various examples. Cloud payment device 601 may generate a QR code or other graphical code to use one of multiple third-party cloud payment services, or potentially also including a custom cloud payment service option provided by the maker of cloud payment device 601, or a cloud payment service option based on payment via a cryptocurrency or other digital currency via a digital wallet application on smartphone 170, in various examples.

In various examples, a user may use a user device 170 such as smartphone 170 as shown in FIG. 1 to scan a QR code displayed by cloud payment device 601, where the QR code displayed by cloud payment device 601, upon scanning by smartphone 170, enables smartphone 170 to open a cloud payment services software application (“app”) on smartphone 170, which corresponds to the cloud payment service used by cloud payment device 601, or to a selected one of multiple cloud payment services used by cloud payment device 601; and with a designation of a payment-receiving account associated with cloud payment device 601. In various examples, cloud payment device 601 may use a third-party cloud payment service provider such as Venmo, Zelle, or Paypal (each of which are trademarks of their respective owners), and cloud payment device 601 may generate a QR code that, upon scanning by smartphone 170, causes smartphone 170 to open and run (or to download and then open and run, if the app is not previously loaded on smartphone 170) the Venmo, Zelle, or Paypal smartphone app, respectively, or other smartphone app of another third-party cloud payment service provider, or of a cloud payment service provider associated with the maker or owner or operator of cloud payment device 601, in various examples. In at least this way, the cloud payment device 601 generates an output configured for enabling a user device 170 to enter a connection with a cloud payment service to make a payment for the specified price to an account associated with the cloud payment device 601.

Different cloud payment service options may be accessible or preferential in different countries. Cloud payment device 601 may be configured to operate in accordance with preferred or accessible cloud payment service providers or options, either centralized or peer-to-peer cloud payment service providers or options, depending on what country cloud payment device 601 is operating in, in various examples.

The user 179 may then make a payment using the cloud payment service, which may send payment to the account associated with cloud payment device 601. Cloud payment device 601 may have its own linked account, or may be one of multiple devices linked to a single cloud payment service account and have its own designation within that account, for internal association of that particular payment to that particular cloud payment device 601. Cloud payment device 601 may monitor for and confirm receipt of payment, in the user-selected amount, via the cloud payment service. The association of cloud payment device 601 with a payment account with the cloud payment service provider may be previously set up as part of an owner or manager or other user of cloud payment device 601 setting up or initializing cloud payment device 601 into functionality.

Cloud payment device 601 may receive confirmation of payment from the cloud payment service, and may respond to receiving the confirmation of payment from the cloud payment service by sending control signals to the vendor apparatus to engage the vendor apparatus for the user-selected and paid-for number or amount of vendor apparatus services or products performed or dispensed by the vendor apparatus. For example, cloud payment device 601 may send control signals to an automated basketball game apparatus 180 as in FIG. 1 to provide user access to a user-selected and paid-for number of basketballs with which to shoot baskets, or in a photo kiosk vendor apparatus, cloud payment device 601 may send control signals to the photo kiosk vendor apparatus to take a user-selected and paid-for number of photographs of a photographic subject field inside the photo kiosk.

Thus, in various examples, one or more processing components of payment device processor and RAM 602 may thus be configured to run computer-readable instructions loaded in one or more memory components of payment device processor and RAM 602 for payment system software application 605, wherein the payment system software application 605 comprises the components shown in FIG. 6. In particular, in such examples, payment system software application 605 comprises a point-of-sale (POS) application programming interface (API) client module 610, configured for controlling a POS API client; a local application data management module 620, configured for managing local application data; a logger module 630, configured for logging outputs into files; a general-purpose input/output (GPIO) controller module 640, configured for controlling the one or more input/output interfaces; and a view model module 650, configured for controlling outputs to the one or more display components.

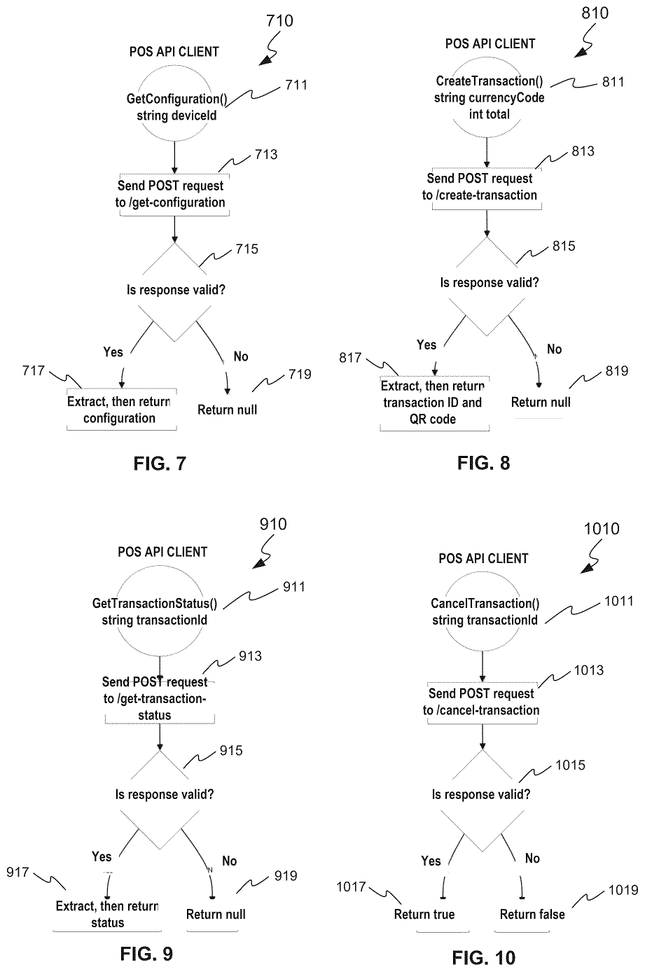

FIGS. 7-14 depict components of software code, in illustrative examples of this disclosure. FIGS. 7-14 depict components of software code in conceptual flowchart forms that combine logical statements, code statements which may include elements of pseudocode and/or code in Java or another implemented software language, with variable names in generally accepted Java protocol such as camel case, such as “logLevel” and “filePath,” and hypertext transfer protocol (HTTP) commands, such as “POST request.” Such depictions are illustrative and not limiting; any of the concepts depicted therein and described in connection therewith may be implemented in any software language and using any protocols, in various embodiments of this disclosure. FIGS. 7-15 depict and describe individual elements of software in terms of lines, which may be indicative of commands, lines of code, or logical elements, in representative and non-limiting examples, which may be implemented analogously in any programming language or comparable firmware or hardware, in various examples of this disclosure. All of the modules and module elements described below are discussed in terms of modules and module elements that a cloud payment device of this disclosure may run, process, or carry out.

FIG. 7 depicts a POS API client software module 710, in accordance with an illustrative example of this disclosure. POS API client software module 710 may be a component of POS API client module 610 as depicted in FIG. 6, and of payment system software application 605 loaded and running on processor 102 and RAM 104 of FIG. 2 and/or payment device processor and RAM 602 as depicted in FIG. 6, in accordance with various examples of this disclosure.

POS API client software module 710 comprises a line (a “line” here and hereinafter may be implemented as, e.g., one or more lines of code, one or more processes, one or more commands, or one or more logical elements) “GetConfiguration( ) string deviceId” (711), followed by a line “Send POST request to /et-configuration” (713), here and hereinafter referring to HTTP commands such as a “POST” command. POS API client software module 710 further includes a line or if-then statement or decision point, “Is response valid?” (715), and determines a yes or no answer to line 715. In response to determining an answer of yes to line 715, POS API client software module 710 includes and carries out a line “Extract, then return configuration” (717). In response to determining an answer of no to line 715, POS API client software module 710 includes and carries out a line “Return null” (719).

FIG. 8 depicts a POS API client software module 810, in accordance with an illustrative example of this disclosure. POS API client software module 810 may be a component of POS API client module 610 and of payment system software application 605 loaded and running on processor 102 and RAM 104 of FIG. 2 and/or payment device processor and RAM 602 as depicted in FIG. 6, in accordance with various examples of this disclosure.

POS API client software module 810 comprises a line (e.g., a command, line of code, or logical element) “CreateTransaction( ) string currencyCode int total” (811), followed by a line “Send POST request to /create-transaction” (813). POS API client software module 810 further includes a line or decision point, “Is response valid?” (815), and determines a yes or no answer to line 815. In response to determining an answer of yes to line 815, POS API client software module 810 includes and carries out a line “Extract, then return transaction ID and QR code” (817). In response to determining an answer of no to line 815, POS API client software module 810 includes and carries out a line “Return null” (819).

FIG. 9 depicts a POS API client software module 910, in accordance with an illustrative example of this disclosure. POS API client software module 910 may be a component of POS API client module 610 and of payment system software application 605 loaded and running on processor 102 and RAM 104 of FIG. 2 and/or payment device processor and RAM 602 as depicted in FIG. 6, in accordance with various examples of this disclosure.

POS API client software module 910 comprises a line (e.g. a command, line of code, or logical element) “GetTransactionStatus( ) string transactionId” (911), followed by a line “Send POST request to /et-transaction-status” (913). POS API client software module 910 further includes a line or decision point, “Is response valid?” (915), and determines a yes or no answer to line 915. In response to determining an answer of yes to line 915, POS API client software module 910 includes and carries out a line “Extract, then return status” (917). In response to determining an answer of no to line 915, POS API client software module 910 includes and carries out a line “Return null” (919).

FIG. 10 depicts a POS API client software module 1010, in accordance with an illustrative example of this disclosure. POS API client software module 1010 may be a component of POS API client module 610 and of payment system software application 605 loaded and running on processor 102 and RAM 104 of FIG. 2 and/or payment device processor and RAM 602 as depicted in FIG. 6, in accordance with various examples of this disclosure.

POS API client software module 1010 comprises a line (e.g., a command, line of code, or logical element) “CancelTransaction( ) string transactionId” (1011), followed by a line “Send POST request to /cancel-transaction” (1013). POS API client software module 1010 further includes a line or decision point, “Is response valid?” (1015), and determines a yes or no answer to line 1015. In response to determining an answer of yes to line 1015, POS API client software module 1010 includes and carries out a line “Return true” (1017). In response to determining an answer of no to line 1015, POS API client software module 910 includes and carries out a line “Return false” (1019).

FIG. 11 depicts a local app data management module 1120, in accordance with an illustrative example of this disclosure. Local app data management module 1120 may be a component of local app data management module 620 and of payment system software application 605 loaded and running on processor 102 and RAM 104 of FIG. 2 and/or payment device processor and RAM 602 as depicted in FIG. 6, in accordance with various examples of this disclosure.

Local app data management module 1120 comprises a line (e.g., a command, line of code, or logical element) “SaveBytes( ) string filePath byte[] content” (1111), followed by a line “Save bytes to a file at filePath” (1113). Local app data management module 1120 further comprises a line “LoadBytes( ) string filePath” (1115), followed by a line “Return bytes from a file at filePath” (1117).

FIG. 12 depicts a logger module 1230, in accordance with an illustrative example of this disclosure. Logger module 1230 may be a component of logger module 630 and of payment system software application 605 loaded and running on processor 102 and RAM 104 of FIG. 2 and/or payment device processor and RAM 602 as depicted in FIG. 6, in accordance with various examples of this disclosure. Logger module 1230 comprises a line (e.g. a command, line of code, or logical element) “Log( ) LogLevel logLevel string message” (1211), followed by the lines “Combine the logLevel, current time, and message together; append the text to the end of a log file” (1213).

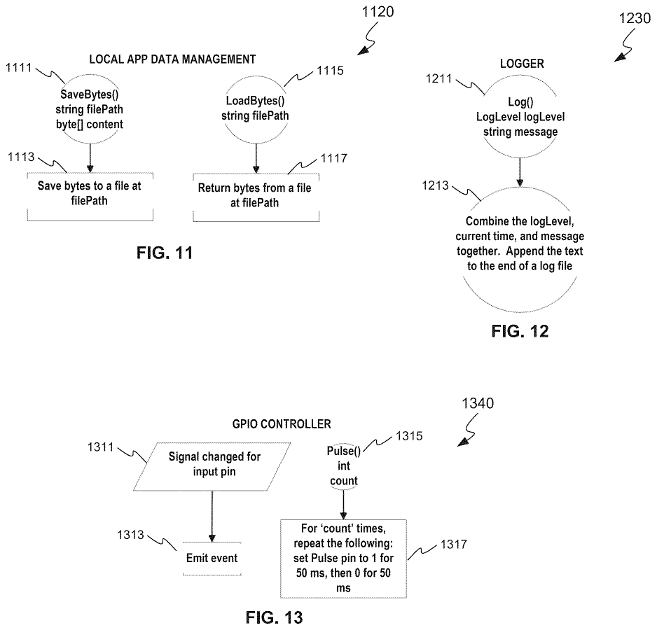

FIG. 13 depicts a GPIO controller module 1340, in accordance with an illustrative example of this disclosure. GPIO controller module 1340 may be a component of GPIO controller module 640 and of payment system software application 605 loaded and running on processor 102 and RAM 104 of FIG. 2 and/or payment device processor and RAM 602 as depicted in FIG. 6, in accordance with various examples of this disclosure.

GPIO controller module 1340 comprises a line (e.g. a command, line of code, or logical element) “Signal changed for input pin” (1311), followed by a line “Emit event” (1313). GPIO controller module 1340 further comprises a line “Pulse( ) int count” (1315), followed by a line “For ‘count’ times, repeat the following: set Pulse pin to 1 for 50 milliseconds (ms), then 0 for 50 ms” (1317).

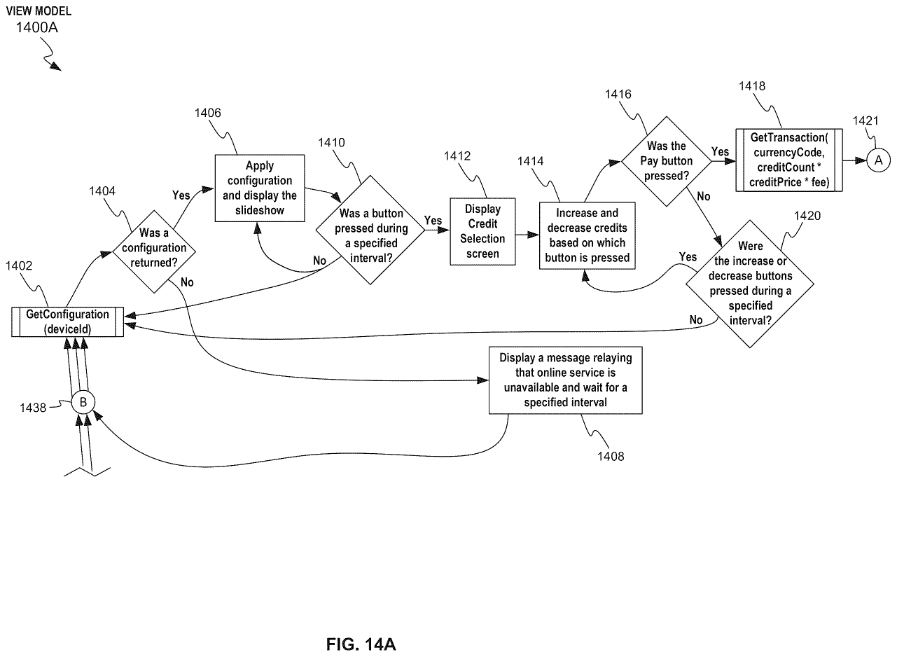

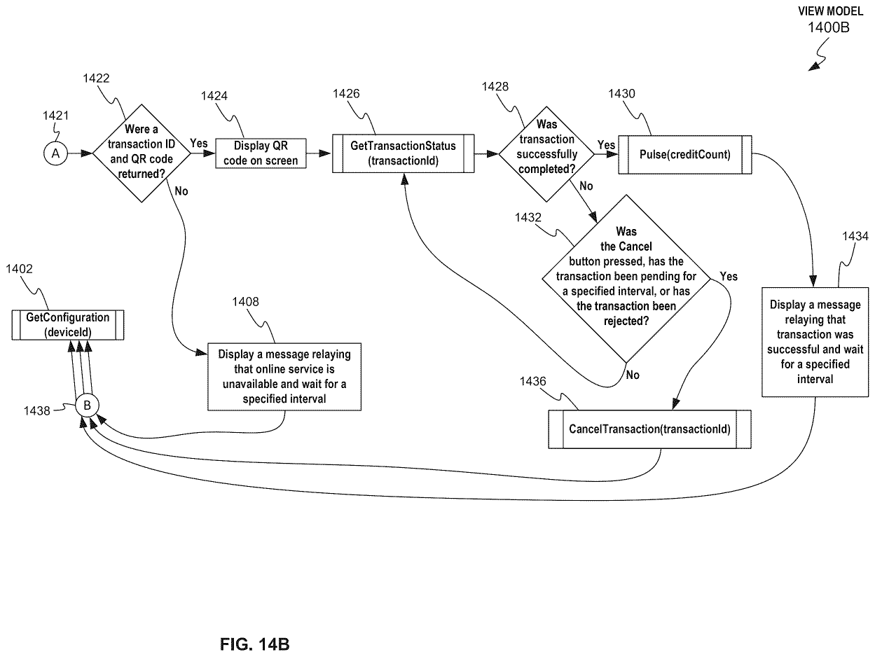

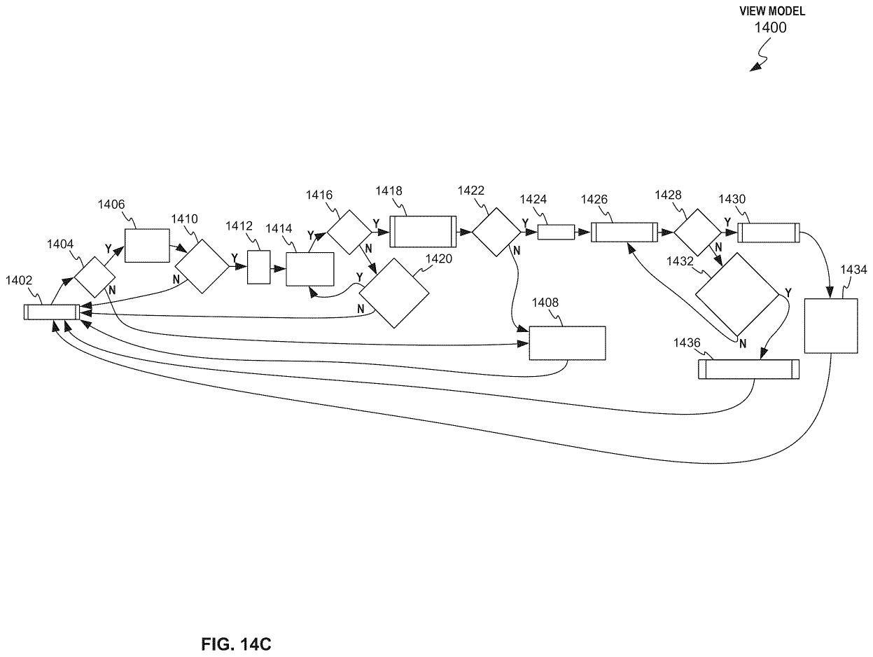

FIGS. 14A-14C depict a view model module 1400 which cloud payment device 101 may run, perform, or process through, in accordance with an illustrative example of this disclosure. In particular, FIG. 14A depicts a view model 1400A which is a first portion of the view model module 1400; FIG. 14B depicts a view model 1400B which is a latter portion of the view model module 1400; and FIG. 14C depicts a complete view of the view model module 1400, in a zoomed-out view that omits some detail, while FIGS. 14A and 14B depict respective portions of view model 1400 in zoomed-in views enabling showing of greater detail, in the form of view models 1400A and 1400B. Elements of portion view model modules 1400A and 1400B are discussed below as elements of view model module 1400, with the understanding that they are depicted and described with respect to both the more detailed views of portion view models 1400A or 1400B of FIG. 14A or 14B respectively and of view model module 1400 depicted in FIG. 14C.

View model module 1400 may be a component of view model module 650 and of payment system software application 605 loaded and running on processor 102 and RAM 104 of cloud payment device 201 of FIG. 2 and/or payment device processor and RAM 602 of cloud payment device 601 as depicted in FIG. 6, in accordance with various examples of this disclosure. The description of all of the elements of view model module 1400 includes description of the functions explicit or implicit in the text, commands, code, or pseudocode depicted in and ascribed to each of the elements, and all or some of which a cloud payment device of this disclosure such as cloud payment device 101-601 may run and perform, in various examples.

View model module 1400 of a cloud payment software application of a cloud payment device 101-601 is illustratively discussed below in terms of representative cloud payment device 101 running view model module 1400 and running algorithmic lines and decision points of view model module 1400, or performing method steps or functions of view model module 1400, with the understanding that the description may equivalently pertain to any of cloud payment devices 101-601 and/or any other embodiment of a cloud payment device of this disclosure running view model module 1400 in various examples. Cloud payment device 101 may generally run and use the computer-readable instruction software of view model module 1400 to generate, function, and enable a series of user interface screen views on a display screen of cloud payment device 101, for user interaction for making selections with regard to a service or product provided by a vendor apparatus controlled by cloud payment device 101, and for making payments facilitated by cloud payment device 101 for usage of the vendor apparatus, and for corresponding control of the vendor apparatus, in various examples.

As a general overview, explained in more detail as follows, cloud payment device 101 may generally use, run, and process view model module 1400 to generate first and second display screen views to notify a potential user about the vendor apparatus, its purpose and its services or products to be offered, and how to use and engage with the vendor apparatus, and to select its services or products. Cloud payment device 101 may generally use view model module 1400 to generate a third display screen view to display an amount of credits or an analogous quantity indicator that may be selected by the user, one or more indicators or buttons to select to increase or decrease the amount of credits or analogous indicator, and one or more indicators or buttons to pay for a currently selected amount or analogous indicator. Cloud payment device 101 may generally use view model module 1400 to generate a fourth display screen view to display a graphical code, such as a QR code, for engaging with and using a cloud payment service provider to make a payment for the selected number of credits via the cloud payment service provider to an account associated with cloud payment device 101. Cloud payment device 101 may also include, as part of the fourth display screen view, or elsewhere, a button or other graphical user element indicated as an option to cancel the proposed transaction.

With view model module 1400, cloud payment device 101 may run an instruction line “GetConfiguration(deviceId)” (1402), which may serve as an initial default state of view model module 1400. With line 1402, cloud payment device 101 may initially seek to establish control communications with a vendor apparatus, and retrieve a configuration of a vendor apparatus with a given vendor apparatus device identification (“deviceId”). Line 1402 may be followed by a decision point to check if a configuration was returned, e.g., “Was a configuration returned?” (1404). Cloud payment device 101 may generally receive a returned nominal configuration of a vendor apparatus, in fulfillment of the condition of decision point 1404, if cloud payment device 101 is operatively coupled to a vendor apparatus. View model module 1400 further comprises, in response to a “Yes” determination of decision point 1404, a line “Apply configuration and display the slideshow” (1406). Cloud payment device 101 may apply a configuration that corresponds with the coupled vendor apparatus, and display, on a display screen thereof, one or more display screen views thereof, a display of information related to and with graphical indications indicative of the connected vendor apparatus and aspects of the services or products it offers.

View model module 1400 further comprises, in response to cloud payment device 101 making a “No” determination of decision point 1404, cloud payment device 101 running an instruction line, “Display a message relaying that online service is unavailable and wait for a specified interval” (1408). Subsequent to instruction line 1408, and a specified interval of time, view model module 1450 may return to the state of instruction line 1402.

View model module 1400 further comprises, subsequent to line 1406, cloud payment device 101 running or processing through a decision point, “Was a button pressed during a specified interval?” (1410). Cloud payment device 101 may thus detect if a potential user enters an input, corresponding to an intent to engage with the connected vendor apparatus. View model module 1400 further comprises, in response to cloud payment device 101 making a “Yes” determination at decision point 1410, cloud payment device 101 running a line, “Display Credit Selection screen” (1412), followed by running a line, “Increase and decrease credits based on which button is pressed” (1414).

Cloud payment device 101 may thus be triggered to run line 1412 by cloud payment device 101 running view model module 1400 receiving an initial input, such as from a user input to select a user interface button displayed on the display screen of the cloud payment device, in this example. Cloud payment device 101 may also be triggered to run line 1412 in response to receiving or detecting an input such as from a user device 170 such as smartphone 170 of FIG. 1, in various examples. Such an initial input from a user device 170 may also be due to a user 179 bringing smartphone 170 proximate to cloud payment device 101 or scanning display screen 116 of cloud payment device 101 with smartphone 170, in some examples.

Cloud payment device 101 running line 1412 may include cloud payment device 101 displaying a user-selectable menu of available vendor apparatus services or products and corresponding prices, such as the menu of user-selectable numbers of basketball throws with corresponding prices, as cloud payment device 301 displays in the example of FIG. 3. View model module 1400 also comprises cloud payment device 101 responding to a “No” determination at decision point 1410, if intervals of time pass without any user inputs, by returning to either or both of line 1402 or line 1406, at different times or in different embodiments.

View model module 1400 further comprises, subsequent to line 1414, cloud payment device 101 processing a decision point, “Was the pay button pressed?” (1416). View model module 1400 further comprises, in response to a “Yes” determination at decision point 1416, cloud payment device 101 running a line “GetTransaction(currencyCode, creditCount*creditPrice*fee)” (1418). This is an example of cloud payment device 101 computing a transaction amount for a user-selected amount of credits or equivalent quantity indicator for services or products to be provided by the vendor apparatus. View model module 1400 then progresses from cloud payment device 101 running line 1418 through node A (1421), which is depicted as a connecting node to connect further elements of view model module 1400 that stem from node 1421 into the depiction of FIG. 14B of the latter portion of view model module 1400.

View model module 1400 further comprises, in response to a “No” determination at decision point 1416, cloud payment device 101 processing another decision point: “Were the increase or decrease buttons pressed during a specified interval?” (1420). In response to cloud payment device 101 making a “Yes” determination at decision point 1420, view model module 1400 includes cloud payment device 101 returning to line 1414, indicative of a user having still been operating the view screen to make selections for the vendor apparatus. In response to cloud payment device 101 making a “No” determination at decision point 1420, after an interval long enough to be indicative of a potential user having abandoned the interface menu view screen, view model module 1400 includes cloud payment device 101 returning to its initial default state of line 1402.

Line 1418 and node 1421 of the module portion 1400A of view model module 1400 shown in FIG. 14A lead to module portion 1400B of view model module 1400 shown in FIG. 14B. FIG. 14B also shows node 1421 which serves as a connecting node in the process flow of view model module 1400 as depicted between FIGS. 14A and 14B.

As FIG. 14B further shows of view model module 1400, line 1418 leads (via node 1421) to cloud payment device 101 processing decision point 1422, and with reference to an illustrative example using a QR code as a graphical code, “Were a transaction ID and QR code returned?” In response to cloud payment device 101 making a “Yes” determination at decision point 1422, view model module 1400 includes cloud payment device 101 progressing to line 1424, “Display QR code on screen,” and then line 1426, “GetTransactionStatus(transactionId),” which may be in reference to a transaction status input from the cloud service payment provider, in response to a transaction initiated between the user's user device and the cloud service payment provider by the user device scanning the QR code or other graphical code. A cloud payment device of this disclosure running line 1424 may output for display a QR code along with the corresponding user-selected quantity of service or product and the corresponding price in one display view, in some examples, as cloud payment device 101 outputs for display in the example of FIG. 1. View model module 1400 may then include cloud payment device 101 progressing to decision point 1428, “Was transaction successfully completed?”

In response to a “No” determination at decision point 1422, view model module 1400 includes cloud payment device 101 progressing to line 1408, “Display a message relaying that online service is unavailable and wait for a specified interval.” Line 1408 as shown in FIG. 14B may be identical to line 1408 as shown in FIG. 14A. As described above, view model module 1400 includes cloud payment device 101 proceeding from line 1408 back to its initial default state of line 1402. FIGS. 14B and 14A depict connecting node B 1438 to clarify the process flows from lines of view model module 1400 depicted in both FIGS. 14A and 14B back to initial default state line 1402.

As noted, view model module 1400 further comprises that after running line 1426, cloud payment device 101 progresses to decision point 1428, “Was transaction successfully completed?” with reference to the specified transaction. View model module 1400 further comprises cloud payment device 101 responding to a “Yes” determination from decision point 1428 by progressing to line 1430, “Pulse(creditCount),” which may correspond to incrementing or otherwise populating a counter or register of credits or equivalents for a user-selected and paid-for amount of vendor apparatus service or products in the processed transaction, corresponding with cloud payment device 101 controls the vendor apparatus to provide or dispense the selected quantity of the selected service or product of the specified transaction, in various examples. Separately from view model module 1400 for display screen views that cloud payment device 101 displays on its display screen, cloud payment device 101 may also respond to a confirmed paid-for transaction by controlling the vendor apparatus to provide the user-selected and paid-for amount of vendor apparatus service or products of the processed transaction, in various examples. View model module 1400 further comprises cloud payment device 101 progressing from line 1430 to line 1434, “Display a message relaying that transaction was successful and wait for a specified interval,” which cloud payment device 101 may display in parallel with controlling the vendor apparatus to complete the specified transaction. View model module 1400 further comprises cloud payment device 101 progressing from line 1434 back to the initial default state of line 1402.

View model module 1400 further comprises cloud payment device 101 responding to a “No” determination from decision point 1428 by progressing to decision point 1432, “Was the Cancel button pressed, has the transaction been pending for a specified interval, or has the transaction been rejected?” These are illustrative example cancellation conditions, and an equivalent algorithmic cancellation condition decision point may also contain other cancellation conditions and any combination thereof in other examples. View model module 1400 comprises cloud payment device 101 responding to a “No” determination from decision point 1432 by returning to line 1426, and comprises cloud payment device 101 responding to a “Yes” determination from decision point 1432 by proceeding to line 1436, “CancelTransaction(transactionId),” and returning to the initial default state of line 1402.

As noted above, FIG. 14C shows another view of view model module 1400. FIG. 14C thus recapitulates FIGS. 14A and 14B but in a zoomed-out integrated whole, thus facilitating a view of the view model module 1400 and its complete process flow as shown in the combination of both of FIGS. 14A and 14B.

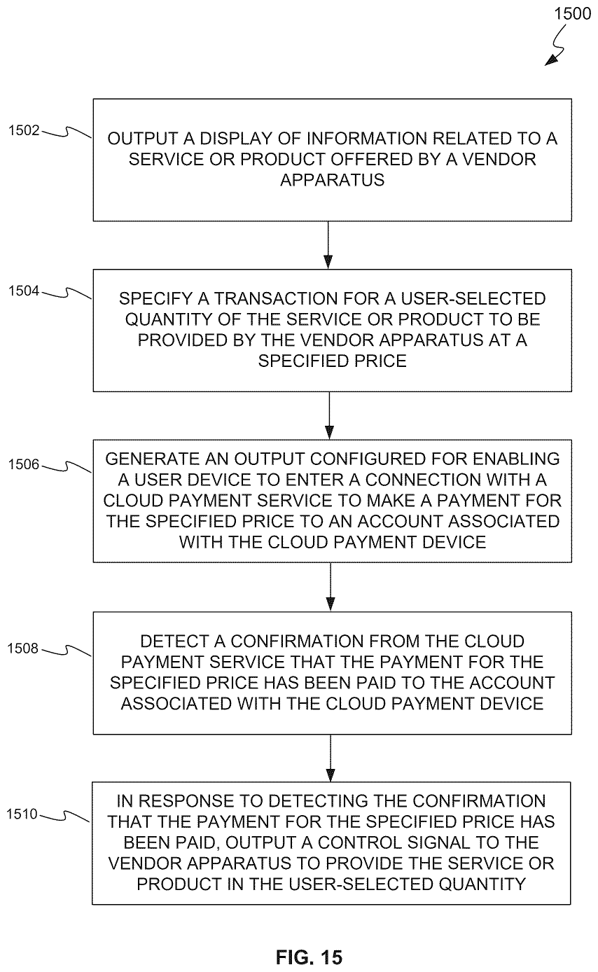

FIG. 15 shows a flowchart of an example method 1500, in accordance with an illustrative example of this disclosure. Aspects of method 1500 may overlap with a method of payment software application 605 of FIG. 6, in various examples. Aspects of method 1500 may further overlap with the modules of FIGS. 7-14, in various examples. A cloud payment device of this disclosure, such as any of cloud payment devices 101-601, may perform method 1500 or aspects of method 1500. Method 1500 is described below illustratively with reference to representative cloud payment device 101, with the understanding that the description may equivalently pertain to any of cloud payment devices 101-601 and/or any other embodiment of a cloud payment device of this disclosure.

In this example, in illustrative aspects comprised in method 1500, cloud payment device 101 may output a display of information related to a service or product offered by a vendor apparatus (1502). Outputting the graphical user interface display by cloud payment device 101 indicative of aspects of a service or product offered by a vendor apparatus (1502) may include cloud payment device 101 displaying graphical user interface display indications of different available quantities of a service or product to be provided by the vendor apparatus, and prices for each of the different quantities, in various examples. Displaying the graphical user interface display by cloud payment device 101 indicative of aspects of a service or product offered by a vendor apparatus (1502) may include cloud payment device 101 running or implementing the line “Apply configuration and display the slideshow” (1406) as described above, in various examples.

In further illustrative aspects, method 1500 further comprises cloud payment device 101, in response to one or more user selection inputs, specifying a transaction for a user-selected quantity of the service or product to be provided by the vendor apparatus at a specified price (1504). Specifying a transaction for a user-selected quantity of the service or product to be provided by the vendor apparatus at a specified price may include aspects of cloud payment device 101 displaying a credit selection screen (running line 1412), increasing and decreasing credits based on buttons selected (line 1414), determining when a pay button is selected (running decision point 1416), and specifying a transaction by running line 1418, “GetTransaction(currencyCode, creditCount*creditPrice*fee),” as described above.

In further illustrative aspects, method 1500 further comprises cloud payment device 101 generating an output configured for enabling a user device to create a connection with a cloud payment service to make a payment for the specified price to an account associated with cloud payment device 101 (1506). Cloud payment device 101 generating the output (1506) may include cloud payment device 101 or an associated service or system generating a transaction identifier (ID) of the specified transaction and a graphical code such as a QR code indicating and associated with the transaction ID of the specified transaction. Cloud payment device 101 outputting a code (1506) may include cloud payment device 101 determining that a transaction ID and QR code for the specified transaction are returned (running decision point 1422), as described above. Cloud payment device 101 generating the output (1506) may include cloud payment device 101 outputting for display a QR code (running line 1424) or other graphical code configured for enabling a user device to create or otherwise enter a connection with a cloud payment service to make a payment for the specified price to an account associated with cloud payment device 101, in various examples.

Cloud payment device 101 generating the output (1506) may include cloud payment device 101 outputting for display a graphical code which, when scanned by a user device, causes the user device to use a cloud payment application loaded on the user device to pull up the specified transaction, including the specified price, and the account associated with cloud payment device 101 as a recipient account to which the specified price is to be paid. Cloud payment device 101 generating the output (1506) may include cloud payment device 101 outputting for display a graphical code which, when scanned by a user device, causes the user device to first confirm that the user device has the user device application of the cloud payment service provider loaded on it, and, if not, to prompt the user device to seek user permission for downloading and opening the cloud payment service provider's application, in various examples.

Cloud payment device 101 generating the output (1506) may further include cloud payment device 101 outputting for display a graphical code that encodes computer-readable instructions which, when scanned by a user device, causes the user device to select, or to prompt a user selection of, one of multiple available cloud payment service providers that are compatible with cloud payment device 101, in various examples. For example, cloud payment device 101 may have cloud payment accounts with multiple cloud payment service providers, and the code cloud payment device 101 generates may cause the user device to first check if the user device has loaded thereon a cloud payment application for a first cloud payment service provider, and use that cloud payment application if it is loaded on the user device, and if it is not loaded on the user device, to then check if the user device has loaded thereon a cloud payment application for a second cloud payment service provider, and if so, then to use that cloud payment application for that second cloud payment service provider. In various examples, cloud payment device 101 may have its own associated cloud payment service, or another first preferred cloud payment service provider, and may generate the code such that the code causes the user device to check and try to use cloud payment service applications in a preferred order on the user device.

In further illustrative aspects, method 1500 further comprises cloud payment device 101 detecting a confirmation from the cloud payment service that the payment for the specified price has been paid to the account associated with cloud payment device 101, via the cloud payment service (1508). Cloud payment device 101 detecting the confirmation that the payment for the specified price has been paid (1508) may include cloud payment device 101 implementing line 1426, “GetTransactionStatus(transactionId),” and decision point 1428, “Was transaction successfully completed?” and determining a “Yes” or affirmative result of decision point 1428, as discussed above with reference to FIGS. 14B-14C, thereby determining that the specified price has been paid via the cloud payment service for the specified transaction for the selected quantity of the selected service or product from the vendor apparatus, in various examples.

In further illustrative aspects, method 1500 further comprises cloud payment device 101, in response to detecting the confirmation that the payment for the specified price has been paid, outputting a control signal to the vendor apparatus to provide the service or product in the user-selected quantity (1510). Cloud payment device 101 outputting the control signal to the vendor apparatus to provide the user-selected quantity of the service or product may include cloud payment device 101 implementing line 1430, “Pulse(creditCount),” as discussed above with reference to FIG. 14B, in various examples. Cloud payment device 101 may then run line 1434 and display a message confirming that the specified transaction was successfully processed. Cloud payment device 101 may then return in its view model module 1400 back to the initial default state of line 1402, as discussed above, in various examples.

Example methods of this disclosure such as method 1500 may be performed by a cloud payment system such as cloud payment system 100 of FIG. 1, which may be implemented as cloud payment device 101 in itself, in some examples, and may include additional elements external to cloud payment device 101 in some examples. In various examples, cloud payment system 100 or cloud payment device 101 may further include an integrated or operably coupled vendor apparatus such as automated basketball game apparatus 180. In various examples, cloud payment system 100 may include a cloud payment service running in cloud services system 160. In an illustrative example, cloud payment system 100 implemented as cloud payment device 101 may perform method 1500.

A device of this disclosure (e.g., cloud payment devices 101-601) may thus include one or more processing components, such as processor 102 of FIG. 2; one or more memory components, such as RAM 104 of FIG. 2, operably coupled to the one or more processing components; one or more display components, such as display module 117 of FIG. 2 and display screens 116, 216, 316 of FIGS. 1-3, operably coupled to the one or more processing components; and one or more input/output interfaces, such as I/O interfaces 110 of FIG. 2, operably coupled to the one or more processing components. A device of this disclosure, such as any of cloud payment devices 101-601, may be configured to perform methods of this disclosure, such as method 1500, and methods that implement the software modules of FIGS. 7-14.

In various examples, cloud payment device 101 or another implementation of cloud payment system 100 may perform further method steps. In various examples, generating an output configured for enabling the user device to enter a connection with a cloud payment service to make a payment for the specified price to the account associated with cloud payment system 100, may further include cloud payment system 100 outputting a graphical code that encodes computer-readable instructions configured to enable the user device to enter a connection with a specified cloud payment service to make a payment for the specified price to the account associated with the cloud payment system. In various examples, cloud payment system 100 outputting the display of information related to a service or product offered by a vendor apparatus may include displaying a plurality of available quantities of the service or product, and displaying corresponding prices for the plurality of available quantities of the service or product. In various examples, cloud payment system 100 specifying the transaction for the user-selected quantity of the service or product to be provided by the vendor apparatus at the specified price may further include cloud payment system 100 specifying the transaction in response to one or more user inputs indicating a user-selected value among the available quantities of the service or product.

In various examples, cloud payment device 101 or another implementation of cloud payment system 100 may include one or more processing components, such as processor 102 of FIG. 2, and one or more tangible computer-readable media comprising computer-readable instructions stored thereon, such as data storage 106 of FIG. 2, for causing the one or more processing components to perform method steps of methods of this disclosure, such as method 1500 of FIG. 15. The computer-readable instructions may be configured for causing the one or more processing components to output a display of information related to a service or product offered by a vendor apparatus (1502). The computer-readable instructions may be further configured for causing the one or more processing components to specify a transaction for a user-selected quantity of the service or product to be provided by the vendor apparatus at a specified price (1504).

The computer-readable instructions may be further configured for causing the one or more processing components to generate an output configured for enabling a user device to enter a connection with a cloud payment service to make a payment for the specified price to an account associated with the cloud payment system (1506). The computer-readable instructions may be further configured for causing the one or more processing components to detect a confirmation from the cloud payment service that the payment for the specified price has been paid to the account associated with the cloud payment system (1508). The computer-readable instructions may be further configured for causing the one or more processing components to, in response to detecting the confirmation that the payment for the specified price has been paid, output a control signal to the vendor apparatus to provide the service or product in the user-selected quantity (1510). In various examples, cloud payment system 100 may further include a cloud services system, such as cloud services system 160 or elements thereof which form a cloud services system, configured to run the cloud payment service.

In various examples, generating the output configured for enabling the user device to enter a connection with a cloud payment service to make a payment for the specified price to the account associated with the cloud payment device, may include outputting a graphical code that encodes computer-readable instructions configured to enable the user device to enter a connection with a specified cloud payment service to make a payment for the specified price to the account associated with the cloud payment device. Outputting the graphical code may include outputting a QR code that encodes the computer-readable instructions configured to enable the user device to enter a connection with the specified cloud payment service to make a payment for the specified price to the account associated with the cloud payment device. In various examples, generating the output configured for enabling a user device to enter a connection with a cloud payment service to make a payment for the specified price to the account associated with the cloud payment device, may also include outputting for display a graphical code that encodes computer-readable instructions which, when scanned by a user device, causes the user device to select, or to prompt a user selection of, one of multiple available cloud payment service providers.

In various examples, outputting the display of information related to a service or product offered by a vendor apparatus may include displaying indications of a plurality of available quantities of the service or product; and displaying corresponding prices for the plurality of available quantities of the service or product. In various examples, the device may be configured such that specifying the transaction for the user-selected quantity of the service or product to be provided by the vendor apparatus at the specified price includes specifying the transaction in response to one or more user inputs indicating a user-selected value among the available quantities of the service or product.

In various examples, displaying the indications of the plurality of available quantities of the service or product and displaying the corresponding prices for the plurality of available quantities of the service or product may include a cloud payment device displaying an initial default indication of quantity of the service or product, and a corresponding price for the initial default quantity; and displaying a user-selectable up button and a user-selectable down button. In various examples, a cloud payment device may be configured to, in response to one or more user inputs to the up button or the down button, display respectively higher or lower indications of quantities of the service or product and respectively higher or lower corresponding prices. In various examples, displaying the indications of the plurality of available quantities of the service or product and displaying the corresponding prices for the plurality of available quantities of the service or product may include the cloud payment device displaying a user-selectable menu of the available quantities, or of at least some of the available quantities, of the service or product and corresponding prices for the at least some of the available quantities of the service or product, as depicted with cloud payment device 301 displaying the menu on display screen 316 in FIG. 3.

In some examples, a single cloud payment device 101, 201, 301, 401, 501, 601 of this disclosure may offer control of multiple vendor apparatuses. In some examples, multiple cloud payment devices implementing cloud payment devices 101-601 of this disclosure may offer control of any of multiple vendor apparatuses. In these examples, an illustrative cloud payment device 101 may provide user options for which vendor apparatus to select, or for which available one or more services and/or one or more products to select, as part of specifying the transaction.

While certain illustrative examples are provided above, various implementations of this disclosure may make use of any of a variety of technologies to accomplish any of its functions. Cloud payment devices 101-601 and other cloud payment devices of this disclosure may use any suitable control circuitry to implement the module diagrams and flow diagrams in the above examples, such as any suitable integrated circuit or circuits. For example, the control circuitry may be implemented with separate integrated circuits, or fabricated into a single integrated circuit or system on a chip (SoC). In some examples, a cloud payment device of this disclosure comprises a microprocessor executing instructions, the instructions being operable to cause the microprocessor to perform the module diagrams and flow diagrams described herein. The instructions may be stored in any computer-readable medium. In some examples, the instructions may be stored on a non-volatile semiconductor memory device, component, or system external to the microprocessor, or integrated with the microprocessor in an SoC. In some examples, the instructions are stored on a flash drive or data storage disk drive and read into a volatile semiconductor memory when the drive is powered on. In some examples, the control circuitry comprises logic circuitry, such as state machine circuitry. In some examples, at least some of the flow diagram blocks may be implemented using analog circuitry (e.g., analog comparators, timers, etc.), and in other examples at least some of the blocks may be implemented using digital circuitry or a combination of analog and digital circuitry.

In various examples, one or more processing devices may comprise or constitute the control circuitry as described herein, and/or may perform one or more of the functions of control circuitry as described herein. In various examples, one or more processing devices of a cloud payment device of this disclosure performing one or more of the functions of a cloud payment device of this disclosure as described herein, may be abstracted away from being physically proximate to the cloud payment device or other components thereof. One or more processing devices of a cloud payment device of this disclosure may be part of or proximate to one or more physical or virtual servers, or may be part of or proximate to one or more local area networks or one or more storage area networks, or may be part of or proximate to a data center, or may be hosted in one or more cloud services, in various examples.

In various examples, computer-readable instructions of a cloud payment device of this disclosure may be stored on a magnetic disk drive, an optical disk drive, a hybrid disk drive, or other types of disk drive. In addition, some examples may include electronic devices such as computing devices, data server devices, media content storage devices, or other devices, components, or systems that may comprise data storage media and/or control circuitry capable of storing and/or running functions and module elements as described above.

The various features and processes described above may be used independently of one another or may be combined in various ways. All possible combinations and subcombinations are within the scope of this disclosure. In some examples, some method, event, or process elements or module lines, decision points, or blocks may be omitted in some implementations. Methods and processes described herein are also not limited to any particular sequence, and devices of this disclosure may perform or implement blocks or states relating thereto in other sequences. For example, devices of this disclosure may perform some described tasks or events in an order other than that specifically disclosed, or may perform multiple described tasks or events in parallel, in overlap, or in combination in a single process, event, block, or state or sequence of states. Devices of this disclosure may perform some example tasks or events in serial, in parallel, or in other manners. Tasks or events may be added to or removed from various disclosed examples. Example systems and components described herein may be configured differently than described. For example, elements may be added to, removed from, or rearranged compared to the disclosed examples.

While certain example embodiments are described herein, these embodiments are presented by way of example only, and do not limit the scope of the inventions disclosed herein. Nothing in the description herein implies that any particular feature, characteristic, step, module, or block is necessary or indispensable. Novel methods and systems described herein may be embodied in a variety of other forms. Various omissions, substitutions and changes in the form of the methods and systems described herein may be made without departing from the spirit and scope of the present disclosure.

All or parts of methods of this disclosure may be performed by or embodied in hardware, and/or performed or executed by a controller, a CPU, an FPGA, a SoC, a multi-processor system on chip (MPSoC), which may include both a CPU and an FPGA, and other elements together in one integrated SoC, or other processing device or computing device processing executable instructions, in controlling other associated hardware, devices, systems, or products in executing, implementing, or embodying various subject matter of the described example methods. Data storage systems, devices, and methods are thus shown and described herein, in various foundational aspects and in various selected illustrative applications, architectures, techniques, and methods for performing aspects of this disclosure. Persons skilled in the relevant fields of art will be well-equipped by this disclosure with an understanding and an informed reduction to practice of a wide panoply of further applications, architectures, techniques, and methods for aspects encompassed by the present disclosure and by the claims set forth below.

As used herein, the recitation of “at least one of A, B and C” is intended to mean “either A, B, C or any combination of A, B and C.” The descriptions of the disclosed examples are provided to enable any person skilled in the relevant fields of art to understand how to make or use the subject matter of the present disclosure. Various modifications to these embodiments will be readily apparent to those skilled in the art based on the present disclosure, and the generic principles defined herein may be applied to other examples without departing from the spirit or scope of the disclosure. Thus, the present disclosure is not limited to the embodiments shown herein but is to be accorded the widest scope consistent with the principles and novel features disclosed herein.

The present disclosure and many of its attendant advantages will be understood by the foregoing description, and various changes may be made in the form, construction, and arrangement of the components without departing from the disclosed subject matter or without sacrificing all of its material advantages. The forms described are merely explanatory, and the following claims encompass and include a wide range of embodiments, including a wide range of examples encompassing any such changes in the form, construction, and arrangement of the components as described herein.

While the present disclosure has been described with reference to various examples, it is understood that these examples are illustrative and that the scope of the disclosure is not limited to them. All subject matter described herein are presented in the form of illustrative, non-limiting examples, and not as exclusive implementations, whether or not they are explicitly called out as examples as described. Many variations, modifications, and additions are possible within the scope of the examples of the disclosure. More generally, examples in accordance with the present disclosure have been described in the context of particular implementations. Functionality may be separated or combined in blocks differently in various examples of the disclosure or described with different terminology, without departing from the spirit and scope of the present disclosure and the following claims. These and other variations, modifications, additions, and improvements fall within the scope of the disclosure as defined in the claims that follow.

What is claimed is:

1. A cloud payment device comprising:
one or more processing components;
one or more memory components, operably coupled to the one or more processing components;
one or more display components, operably coupled to the one or more processing components; and
one or more input/output interfaces, operably coupled to the one or more processing components,
wherein the device is configured to:
output, via the one or more display components, a display of information related to a service or product offered by a vendor apparatus;
specify a transaction for a user-selected quantity of the service or product to be provided by the vendor apparatus at a specified price;
generate an output configured for enabling a user device to enter a connection with a cloud payment service to make a payment for the specified price to an account associated with the cloud payment device;
detect, via the one or more input/output interfaces, a confirmation from the cloud payment service that the payment for the specified price has been paid to the account associated with the cloud payment device; and
in response to detecting the confirmation that the payment for the specified price has been paid, output a control signal to the vendor apparatus to provide the service or product in the user-selected quantity.

2. The cloud payment device of claim 1, wherein generating the output configured for enabling the user device to enter the connection with the cloud payment service to make the payment for the specified price to the account associated with the cloud payment device, comprises:
outputting a graphical code that encodes computer-readable instructions configured to enable the user device to enter a connection with a specified cloud payment service to make a payment for the specified price to the account associated with the cloud payment device.

3. The cloud payment device of claim 2, wherein outputting the graphical code comprises outputting a quick-response code (“QR code”) that encodes the computer-readable instructions configured to enable the user device to enter a connection with the specified cloud payment service to make a payment for the specified price to the account associated with the cloud payment device.

4. The cloud payment device of claim 1, wherein generating the output configured for enabling the user device to enter the connection with the cloud payment service to make the payment for the specified price to the account associated with the cloud payment device, comprises:
outputting for display a graphical code that encodes computer-readable instructions which, when scanned by the user device, causes the user device to select, or to prompt a user selection of, one of multiple available cloud payment service providers.

5. The cloud payment device of claim 1, wherein the device further comprises a tangible payment processing component configured to process payments via one or more of cash and payment cards,
wherein the device is configured to output user options for paying via the cloud payment service or the one or more of cash and payment cards.

6. The cloud payment device of claim 1, wherein the device comprises the cloud payment device, wherein the cloud payment device comprises a frame body,
wherein the frame body is configured to be attached over a face of a separate tangible payment processing device configured to process payments via one or more of cash and payment cards.

7. The cloud payment device of claim 6, wherein the cloud payment device is configured to operably connect with the separate tangible payment processing device, process payments made through the separate tangible payment processing device, and control the vendor apparatus in response to payments processed through the separate tangible payment processing device.

8. The cloud payment device of claim 6, wherein the frame body is further configured with an open slot bezel that is shaped to fit around an input reader slot of the separate payment processing device, such that the open slot bezel of the cloud payment device enables the separate tangible payment processing device to operably receive one or more of cash and payment cards through the open slot bezel of the cloud payment device.

9. The cloud payment device of claim 1, wherein the one or more display components comprises a display screen that is tilted at an intermediate angle relative to a facing plane of the device.

10. The cloud payment device of claim 9, wherein the display screen is tilted such that, in a nominal installed orientation of the device, the intermediate angle is tilted at an upward tilt relative to the facing plane of the device.

11. The cloud payment device of claim 9, wherein the display screen is tilted such that, in a nominal installed orientation of the device, the intermediate angle is tilted at a downward tilt relative to the facing plane of the device.

12. The cloud payment device of claim 1, wherein outputting the display of information related to the service or product offered by the vendor apparatus comprises:
displaying indications of a plurality of available quantities of the service or product; and
displaying corresponding prices for the plurality of available quantities of the service or product, and
wherein the device is configured such that specifying the transaction for the user-selected quantity of the service or product to be provided by the vendor apparatus at the specified price comprises specifying the transaction in response to one or more user inputs indicating a user-selected value among the available quantities of the service or product.

13. The cloud payment device of claim 12, wherein displaying the indications of the plurality of available quantities of the service or product and displaying the corresponding prices for the plurality of available quantities of the service or product comprises:
displaying an initial default indication of quantity of the service or product, and a corresponding price for the initial default quantity; and
displaying a user-selectable up button and a user-selectable down button,
wherein the device is configured to, in response to one or more user inputs to the up button or the down button, displaying respectively higher or lower indications of quantities of the service or product and respectively higher or lower corresponding prices.

14. The cloud payment device of claim 12, wherein displaying the indications of the plurality of available quantities of the service or product and displaying the corresponding prices for the plurality of available quantities of the service or product comprises:
displaying a user-selectable menu of at least some of the available quantities of the service or product and corresponding prices for the at least some of the available quantities.

15. The cloud payment device of claim 1, wherein the one or more processing components are configured to run computer-readable instructions loaded in the one or more memory components for a payment system software application, wherein the payment system software application comprises:
a point-of-sale (POS) application programming interface (API) client module, configured for controlling a POS API client;
a local application data management module, configured for managing local application data;
a logger module, configured for logging outputs into files;
a general-purpose input/output (GPIO) controller module, configured for controlling the one or more input/output interfaces; and
a view model module, configured for controlling outputs to the one or more display components.

16. The cloud payment device of claim 1, wherein the device further comprises the vendor apparatus.

17. A method comprising:
outputting, by a cloud payment system via a display component, a display of information related to a service or product offered by a vendor apparatus;
specifying, by the cloud payment system, a transaction for a user-selected quantity of the service or product to be provided by the vendor apparatus at a specified price;
generating, by the cloud payment system, an output configured for enabling a user device to enter a connection with a cloud payment service to make a payment for the specified price to an account associated with the cloud payment system;
detecting, by the cloud payment system via an input/output interface, a confirmation from the cloud payment service that the payment for the specified price has been paid to the account associated with the cloud payment system; and
in response to detecting the confirmation that the payment for the specified price has been paid, outputting, by the cloud payment system, a control signal to the vendor apparatus to provide the service or product in the user-selected quantity.

18. The method of claim 17, wherein generating the output configured for enabling the user device to enter the connection with the cloud payment service to make the payment for the specified price to the account associated with the cloud payment system, comprises:
outputting a graphical code that encodes computer-readable instructions configured to enable the user device to enter a connection with a specified cloud payment service to make a payment for the specified price to the account associated with the cloud payment system; and
wherein outputting the display of information related to the service or product offered by the vendor apparatus comprises:
displaying a plurality of available quantities of the service or product; and
displaying corresponding prices for the plurality of available quantities of the service or product, and
wherein specifying the transaction for the user-selected quantity of the service or product to be provided by the vendor apparatus at the specified price comprises specifying the transaction in response to one or more user inputs indicating a user-selected value among the available quantities of the service or product.

19. A cloud payment system comprising:
one or more processing components; and
one or more tangible computer-readable media comprising computer-readable instructions stored thereon, wherein the computer-readable instructions are configured for causing the one or more processing components to:
output a display of information related to a service or product offered by a vendor apparatus;
specify a transaction for a user-selected quantity of the service or product to be provided by the vendor apparatus at a specified price;
generate an output configured for enabling a user device to enter a connection with a cloud payment service to make a payment for the specified price to an account associated with a cloud payment system;
detect a confirmation from the cloud payment service that the payment for the specified price has been paid to the account associated with the cloud payment system; and
in response to detecting the confirmation that the payment for the specified price has been paid, output a control signal to the vendor apparatus to provide the service or product in the user-selected quantity.

20. The cloud payment system of claim 19, further comprising a cloud services system configured to run the cloud payment service.
